(19) United States
(12) Patent Application Publication
(10) Pub. No.: US 2023/0162240 A1
(43) Pub. Date: May 25, 2023

(54) METHODS AND SYSTEMS FOR SOLICITING AN ANSWER TO A QUESTION

(71) Applicant: Quora, Inc., Mountain View, CA (US)

(72) Inventors: Sandra Liu Huang, Menlo Park, CA (US); Adam D'Angelo, Palo Alto, CA (US); Joel Lewenstein, San Francisco, CA (US); Yair Livne, Palo Alto, CA (US); Gregory N. Price, San Francisco, CA (US)

(21) Appl. No.: 17/822,411

(22) Filed: Aug. 25, 2022

Related U.S. Application Data
(63) Continuation of application No. 13/766,417, filed on Feb. 13, 2013, now abandoned.

(51) Int. Cl. G06Q 30/0273; G06Q 50/00; G06Q 30/0601

(52) U.S. Cl. CPC G06Q 30/0273; G06Q 50/01; G06Q 30/0631

(57) ABSTRACT

Techniques for facilitating the promotion of content are described. Consistent with some embodiments, a content promotion interface is presented with a content item, enabling a user to promote the content item. By promoting the content item, the user can influence one or more algorithms used in selecting and presenting content items to other users, such that the promoted content item is provided preferential processing and may be selected for presentation in situations where it may otherwise not be (e.g., if not promoted), and the promoted content item may be presented in a manner designed to garner more collective user-attention than the content item would otherwise receive, if presented in a conventional manner (e.g., without having been promoted).

### CROSS-REFERENCES TO RELATED APPLICATIONS

The present application is a continuation of U.S. patent application Ser. No. 13/766,417 filed Feb. 13, 2013, which IS hereby incorporated by reference in ITS ENTIRETY for all purposes.

### TECHNICAL FIELD

The present disclosure generally relates to data processing techniques that enable users of a network- or web-based application or service to promote organic content, including application- or system-generated content as well as user-generated content. More specifically, the techniques described herein enable users of an application or service to influence the factors used in a content selection or relevance algorithm, thereby causing promoted content to garner more collective user-attention, for example, when such content is presented via one or more content delivery channels, including a personalized content feed.

### BACKGROUND

Many network-based applications and services that are currently in use, or in development, have a social aspect. For example, users of these applications are encouraged to establish connections with other users, or follow other users, for the purpose of forming virtual communities or forums via which the users can interact with one another and exchange information. Similarly, users of these applications may be encouraged to follow certain content sources, or subscribe to receive information relating to certain topics, answers to certain questions, and so forth. Many of these network-based applications and services rely partially, and in some cases almost entirely, on user-generated content—that is, content generated by the end-users of the particular application or service. The value of such applications and services to the users, and thus the success of any organization providing such applications and services, is heavily dependent upon the ability to attract and retain users who are willing to participate, for example, by consuming content, and/or interacting with other users by generating desirable, quality content that is to be shared with others.

In many instances, the volume of content available for presentation to any one user far exceeds the amount that user can practically view and consume. Accordingly, many applications and/or services have some algorithmic means for determining what specific content items are to be presented to any particular user. For purposes of the present disclosure, such algorithms are referred to as content selection or relevance algorithms. For instance, with many applications and/or services that have a social-aspect, one of the primary content delivery or distribution channels is a content feed, sometimes referred to as an activity stream, content stream, status update stream, news feed, or simply a data feed. Typically, the content items that are presented to any particular user in his or her content feed are selected specifically for that particular user. For instance, the content items that are presented in a particular user's content feed may be selected, for example, using a content selection algorithm, based on the content items having a relationship to some entity (e.g., person, company, question, content board, topic, web page, etc.) with which the user is also associated or related. In the context of a social network service, for example, many of the content items that appear in a particular user's content feed are content items (e.g., individual messages or postings) that have been generated and posted or published by other users with whom the particular user is connected or following. Similarly, in the specific context of a question-and-answer application or service, the content items that are selected for presentation in a particular user's content feed may include content items (e.g., topics, questions, answers, etc.) that have been generated and posted by other users with whom the particular user is connected or following, or, content items relating to particular topics, questions or similar content items, that the particular user has elected to follow, or to which the particular user has otherwise subscribed.

Even when the content items selected for presentation in a content feed are limited to content items having a relationship to some entity with which the user is also associated or related, the volume of presentation-eligible content items may still be greater than what the user can practically consume. This is particularly the case when a user is connected to or is following a large number of other entities (e.g., people, companies, questions, content boards, topics, web pages, etc.), or when a user visits the site infrequently, such that the volume of unread content items increases between visits. As such, content selection algorithms used by many applications and/or services use a relevance algorithm to generate for each presentation-eligible content item a score (e.g., a quality, relevance or ranking score) for use in ranking and selecting the individual content items that are ultimately presented to a particular user. For instance, a relevance algorithm may base the score or rank assigned to a particular content item on a variety of factors, including how recently the content item was posted, the relationship between the user viewing the content item and the user who posted or published the content item, and the overall level of activity or engagement that other users have had with the content item. Of course, a variety of other signals may also be considered when determining the quality or relevance of a content item for purposes of determining whether the content item should be presented to a particular user in a content feed.

While conventional content selection algorithms and relevance algorithms perform reasonably well and tend to improve the overall quality or relevance of content items presented to users, in many instances, a particular item of content may be deemed particularly important to a person. A user may desire that some content receive a significant level of attention or exposure, generally, and/or with a specific category of users. Similarly, a person posting or publishing a content item may desire to have near-immediate feedback from others concerning the content item. In such instances, there is no simple and efficient manner to influence an application or service's content selection and/or relevance algorithms to ensure that a particular content item is presented to and viewed by others.

### DESCRIPTION OF THE DRAWINGS

Some embodiments of the invention are illustrated by way of example, and not limitation, in the figures of the accompanying drawings, in which:

FIG. 1 is a block diagram illustrating some of the functional modules and components used in implementing a question-and-answer service having a content promotion module that allows users to promote content items, consistent with some embodiments of the invention;

FIG. 2 is a flow diagram illustrating an example of the method operations performed when a user of a network-based application or service promotes a content item, according to some embodiments of the invention;

FIG. 3 is a flow diagram illustrating an example of the method operations performed when a set of content items that includes one or more promoted content items is selected for presentation to a user via a content distribution channel of a network-based application or service, consistent with some embodiments of the invention;

FIG. 4 is a user interface diagram illustrating an example of a web page of a question-and-answer service, and in particular a question page having a content promotion interface via which a user can promote a question, consistent with some embodiments of the invention;

FIGS. 5A and 5B are user interface diagrams illustrating alternative user interfaces for a content promotion module via which users can promote content items and specify content promotion parameters and/or user targeting criteria, consistent with some embodiments of the invention;

FIG. 6 is a user interface diagram illustrating an example of a web page of a question-and-answer service, and in particular a question page in which an answer to a question has been promoted, consistent with some embodiments of the invention;

FIG. 7 is a user interface diagram illustrating an example of a web page showing a content stream or feed, including content items that have been promoted, consistent with embodiments of the invention;

FIG. 8 is a user interface diagram illustrating an example of a web page of a question-and-answer service, and in particular a page showing the users who have viewed a particular question, and which of those users viewed the question as a result of that question having been promoted, consistent with some embodiments of the invention; and

FIG. 9 is a block diagram of a machine in the form of a computing device within which a set of instructions, for causing the machine to perform any one or more of the methodologies described herein, may be stored and executed.

### DETAILED DESCRIPTION

Methods and systems for facilitating the promotion of organic content of a network- or web-based application are described. In the following description, for purposes of explanation, numerous specific details are set forth in order to provide a thorough understanding of the various aspects of different embodiments of the present invention. It will be evident, however, to one skilled in the art, that the present invention may be practiced without each and every specific detail set forth herein.

Consistent with embodiments of the present invention, a network- or web-based application or service includes what is referred to herein as a content promotion module that enables a user to select an item of content for promotion. By promoting a content item, the user is able to influence one or more algorithms used in selecting, ranking and/or presenting content items to another user, such that the promoted content item is provided preferential processing and may be selected for presentation in situations where it may otherwise not be (e.g., if not promoted), and the promoted content item may be presented in a manner designed to garner more collective user-attention than the content item would otherwise receive, if presented in a conventional manner (e.g., without having been promoted).

Consistent with embodiments of the present invention, the content items that are eligible for being promoted are organic content items presented to users via one of a number of content delivery channels. In the context of the present disclosure, organic content is content that is generated by some component of the application or system, as well as any user-generated content, but specifically excludes any content, such as advertisements, that may be published or otherwise made available by third parties. Furthermore, in the context of the present disclosure, a channel is a content delivery and presentation mechanism by which content, including system-generated and/or user-generated content, can be communicated and/or presented to users. Various social media applications utilize a variety of different types of content delivery channels to present content to users. For instance, one particular channel is referred to herein as a content feed, but may also be commonly referred to and known by others as an activity stream, content stream, status update stream, news feed, or simply a data feed. Using a content posting module, a user can post or publish some content (e.g., a blog post, a message, a picture, a question, an answer, etc.) to the content feeds of other users. Once posted, the content will appear in the personalized content feeds of any other users who may be connected to, or following, the particular user, or any users who are following a topic to which the posted or published content is related. For example, in the specific case of a question-and-answer service, a user may follow a question, such that, when an answer to the question is posted or published, the answer will automatically be presented in the content feed of the user who is following the question.

Another example of a content delivery channel is email or messaging where each user has an inbox and is provided with the ability to send and receive emails/messages. With some embodiments, email may provide both a mechanism by which users can communicate with one another, and by which application- or system-generated content can be communicated to users. Furthermore, the email or messaging platform may be web-based, or may use any of a variety of conventional email or messaging protocols to allow access by remote client applications. In yet another example, an application or service may provide a system of notifications. A notification channel may, for example, push certain system-generated content to users. For instance, a notification may be generated upon detecting certain conditions or events. When a user provides a comment regarding a content item, indicates that he or she likes a particular content item, or votes up or down a particular content item, a notification may be generated and communicated to the user who authored the particular content item. Similarly, in the particular context of a question-and-answer service, a user may receive a notification, for example, when another user posts an answer to a question that the user is following. A notification channel may be configured to leverage one or more underlying communication mechanisms. For example, notifications may be communicated via email, SMS, a mobile application, or any other applicable means.

When a user promotes a content item, any one of a number of different things may occur to garner more collective user-attention for the promoted content item. For instance, when a content item has been promoted, the promoted content item may be presented more prominently than it would otherwise be if not promoted, for example, by positioning the promoted content item at or near the top of a list of content items, and/or, by modifying the content item's presentation format, so that the color, shape or size of the content item (or some part of the content item) is different from non-promoted content items. Additionally, a promoted content item may be presented to a larger or different audience of users than the users to whom the same content item, if not promoted, would otherwise be presented. Furthermore, a content item that has been promoted may be presented in a content distribution channel that is different from the channel via which the content item was originally posted, published and/or presented. In some instances, a content item that has been promoted may be communicated to users via multiple channels, including one or more channels via which content is pushed to users (e.g., such as email and/or notifications).

If a content item is being presented in a user's content feed, the promoted content item may be presented more prominently in the content feed, for example, by presenting the particular promoted content item at or near the top of the content feed. With some embodiments, this may be achieved by simply manipulating one or more factors used (e.g., by a content selection and/or relevance module) in selecting and determining a relevance or ranking score for content items, where the ranking scores assigned to content items are used to determine which particular content items are selected to be presented to a user, and in what order. Similarly, if the promoted content item is presented via an email, the position of the content item relative to other content items, within the email, may be influenced by the content promotion, such that a promoted content item may appear at or near the top of a list of content items. In the case of web-based mail or messaging, a content promotion may result in the position of an individual email or message being manipulated so that an individual email or message, when promoted, appears at or near the top of a list of emails or messages presented in a user's inbox.

In addition to having an effect on the position of a content item in a content feed, inbox or email, promoting a content item may also affect the format (e.g., color, size, shape, and so forth) of the content item when presented. For example, with some embodiments, a promoted content item may be formatted to draw a user's attention to the fact that the content item has been promoted. In some instances, this may include presenting with the content item an icon, graphic or badge of some type, to indicate that one or more other users have promoted the particular content item. Such an icon, graphic or badge may convey to the viewing user not only information indicating that the content item has been promoted, but also how many people have promoted the content item, and in some instances, the identity (e.g., name, picture, etc.) of the user or users who have promoted the content item. Additionally, the icon, graphic or badge, or a related user interface element, may convey to a user the reach (size of audience) specified for a particular content promotion.

With some embodiments, promoting a content item may cause the content item to be eligible for presentation to a wider audience of users than the content item would otherwise be eligible for presentation, if not promoted. For example, in many instances, when a user is browsing or viewing content via a particular channel (e.g., a content feed), the content items presented via that channel have been selected based on some selection criteria. For example, the content items presented in a content feed of a particular user are typically content items generated by other users to whom the particular user is connected or following, or content items that are associated with or related to some other entity (e.g., a company, question, content board, topic, web page, etc.). In some instances, a content item that has been promoted may become eligible for presentation to users who would otherwise not receive the content. For example, when an item of content assigned to a particular topic is promoted, the item of content may be presented to users who are not following the particular topic, but are following other topics related to the particular topic. Similarly, in the case of a hierarchical topic structure, where topics are arranged in a hierarchy with top-level topics and one or more levels of sub-topics, a promoted item of content assigned to a particular topic may be presented to users who are not following the particular topic, but are following a topic that is a parent topic or child topic to the particular topic to which the item of content is assigned.

In some instances, during the process of promoting a particular item of content, the user promoting the content may be presented with an option to specify some user targeting criteria for use in specifically targeting a particular (e.g., broader, or narrower) audience to receive the promoted content item. Such user targeting may be based on selecting specific topics to target users who follow those topics, or by selecting or specifying certain user profile characteristics. For instance, in the specific context of a question-and-answer application or service, a user may desire that someone provide an answer to an unanswered (or open) question that has been assigned to one or more particular topics. By promoting the question, more users are likely to view the question, thereby ultimately increasing the chance that another user will provide an answer to the question. However, the user who is promoting the question may believe that users following a specific topic other than one of the topics to which the unanswered question is currently assigned may have the best possibility of providing a relevant and meaningful answer. Similarly, a user may believe that other users following one specific topic of the many topics to which a question is assigned will have the best possibility of providing a relevant and meaningful answer. In such scenarios, the user who is promoting the unanswered question may specify that the question be promoted to users who are following some specific topic. Such targeting may be referred to as specific topic targeting. Of course, other targeting criteria may also be specified, including but not limited to: targeting other users who have answered a certain number of questions, or a certain number of questions relating to a particular topic; a geographical location of a user; a user's current online status (e.g., online or offline); users who have answered questions that have received a predetermined or threshold number of upvotes by other users, and/or the speediness or positive rate of users interacting with content (e.g., answering questions).

With some embodiments, promoting a content item may cause the content item to be communicated to one or more others users via one or more additional channels—that is, one or more channels other than the original channel to which the content was initially posted or published. For example, in some instances, when a user promotes a particular content item, the promoted content item may be communicated to a set of users via a notification or email. In such a scenario, the notification will inform the recipient-users of the promoted content and may provide other contextual information, such as, the identity of the user or users who have promoted the content item. The notification may include a copy or version of the promoted content, or a link to another web page or user interface via which the promoted content item can be accessed. In particular, the notification or email may provide a link to the user's content feed, in which the promoted content is presented at or near the top.

In various embodiments, the price to be paid by a user in exchange for requesting that an item of content be promoted may be derived in a variety of ways. For instance, with some embodiments, there may not be any charge to the user for promoting an item of content, but users may be limited to a certain number of promotion requests over a given time period (e.g., one per day, five per week or month, etc.). In other instances, the price a user is to pay in exchange for promoting an item of content may be based in a virtual currency (e.g., credits or points), while in some embodiments, an application or service may include a payment processing module for processing and receiving payments of an actual government-issued currency such as the United States Dollar (USD), for example, by means of a credit card payment or any other electronic payments.

Regardless of the type of currency, virtual or real, with some embodiments an algorithmic price setting mechanism may be utilized with a view to optimizing for some desired objective. For example, with some embodiments, the price for promoting content may be based on, and may fluctuate according to, the overall percentage of promoted content items to non-promoted content items that are appearing in users' content feeds. For instance, to avoid situations in which users are continuously being presented with a high percentage of promoted content, to the exclusion of non-promoted content, the price for promoting content may be adjusted, manually or algorithmically, to achieve a desired mix of promoted and non-promoted content.

With some embodiments, the price for promoting a particular item of content may vary depending on a wide variety of other factors, including certain user characteristics, as well as characteristics of the content being promoted. For example, with some embodiments, the price to promote an item of content will depend upon the reach of the promotion—that is, the particular number of users of the network-based application to whom the content is to be presented by means of the promotion. With some embodiments, the price for promoting an item of content may be personalized for each user and may be based on some metric representing the user's effectiveness in promoting content. For instance, if content promoted by a particular user is regularly well received by others—meaning, the users who view the promoted content actively engage or interact with the content (e.g., by commenting, re-sharing, liking or voting on the content, etc.)—this may affect (decrease) the price that the particular user is requested to pay in exchange for promoting further content generally, or further content associated with a particular topic. With some embodiments, the price a user is to pay to promote a particular item of content may be based on some metric representing a measure of the user's expertise with respect to a particular topic to which the item of content is associated or assigned. For instance, if a recognized expert in a particular topic is promoting a content item that relates to the user's particular topic of expertise, the price for promoting the content item may be adjusted downward. A user may be recognized as an expert with respect to a particular topic, for example, when the user has posted or published a certain number of answers to questions that are assigned to or otherwise related to a particular topic, and a sufficient number of other users have voted up those answers. With some embodiments, the price to promote a particular item of content may be dependent upon some metric representing a measure of quality for the item of content being promoted. For instance, the quality of a content item may be determined in any number of ways, including various measures of user engagement with the content item. With some embodiments, for example, a metric representing the quality of a content item may be based on the number of net positive upvotes that the content item has received, the number of user comments on an item of content, the number of times a content item has been re-shared, the number of times a content item has been viewed or followed, and so forth. Generally, the cost to promote an item of content will be inversely proportional to the quality of the item of content, such that high quality content costs less to promote than poor quality content.

With some embodiments, the price for promoting a particular item of content may depend upon a specific topic to which the content has been assigned, or the overall volume of available content assigned or relating to a particular topic. For example, in the specific context of a question-and-answer service, to motivate users to generate content generally, and specifically to answer questions relating to certain topics, the price for promoting a question relating to some topics may be lowered to entice more people to promote questions relating to those topics. With some embodiments, the price for promoting a content item may vary based on a specified duration of time over which the content is to be promoted. For example, a user may pay more to reach a large audience with a promotion over a very short duration of time, than that user would otherwise pay to reach the same size audience over a longer duration of time. Finally, the price to promote a particular item of content may vary based on some targeting criteria specified by the user making the request to promote the content item. If, for example, a user specifies certain targeting criteria to target a set of users to receive the promoted content and those users are frequently the recipients of others messages and requests, the cost for obtaining the attention of those users may be higher, which may be reflected in the price to target a particular promotion at a certain set of users.

In various embodiments, the specific types of content items that are eligible for promotion will vary. For instance, in the context of a social network service, essentially any type of content that can be presented in a content feed or stream may be eligible for promotion, including blog posts, messages, status updates, photographs and pictures, video and audio files, news articles, as well as links to any of the aforementioned. In the particular context of a question-and-answer application or service, the content items that may be promoted may be categorized as having a particular type, to include: questions, both answered and unanswered (or, open); answers to questions; comments made in association with a question or answer; content boards, or other collections of aggregated content; as well as topics to which questions and answers may be assigned. Of course, in other network or web-based applications, content items may be classified and referred to differently.

Many of the examples and illustrations provided herein describe or present the inventive subject matter in the particular context of a network- or web-based, question-and-answer application or service. However, skilled artisans will immediately recognize a vast number of other contexts, including other network-based applications and services, to which the inventive concepts are applicable. In particular, the inventive concepts described herein will find application in a wide-variety of network- or web-based services, particularly those that host and encourage user-generated content and/or implement or leverage a social media platform enabling users to interact with and exchange information via one or more content distribution channels, including a content feed or stream, email or messaging platform and system of notifications. Some of the specific types of network-based applications or services to which the inventive concepts are applicable include, but are not limited to, email applications, social network services including business and professional network services, music and video services, photograph sharing applications and services, blog hosting services, and many others. Similarly, the inventive concepts described herein are applicable not only to web-based applications and services accessed via a web browser application, but also mobile applications as well as more traditional desktop client applications.

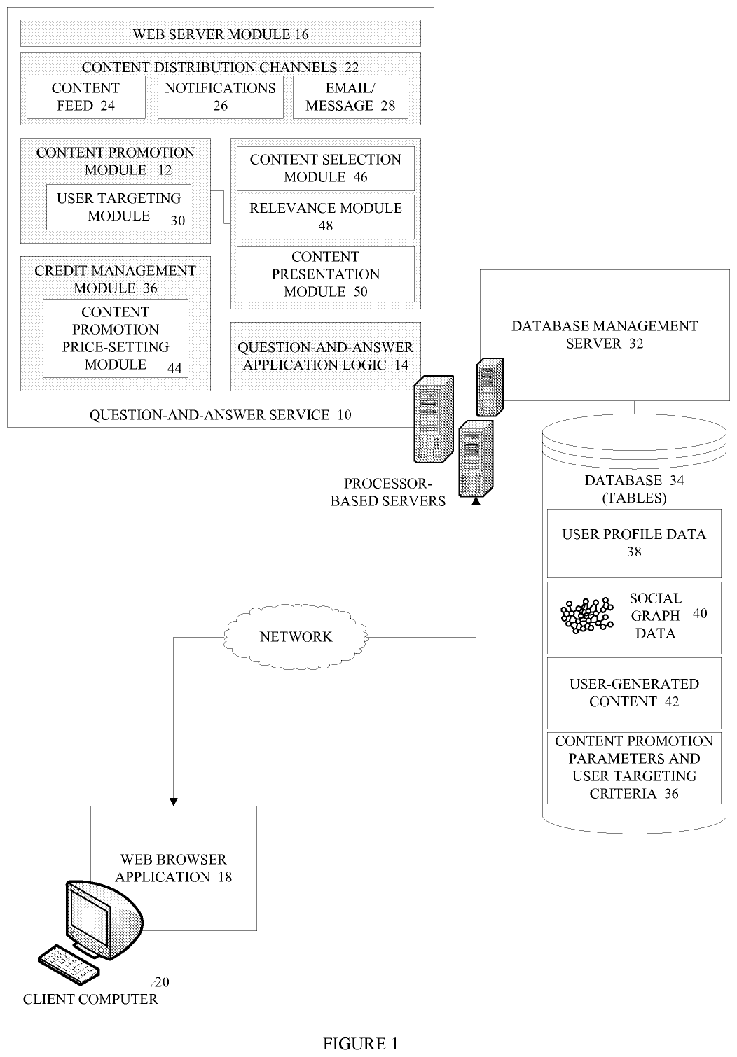

FIG. 1 is block diagram illustrating some of the functional modules and system components used in implementing a question-and-answer service 10 having a content promotion module 12 that allows users to promote content items in accordance with any of the aforementioned techniques and consistent with some embodiments of the invention. As illustrated in FIG. 1, a question-and-answer service 10 is implemented as a web-based application having application logic 14 residing at one or more processor-based computer servers. At least some of the servers include a web server component or module 16 for serving data (e.g., documents or web pages) to a conventional web browser application 18 residing and executing at a client computer 20. In addition, or as an alternative, the web server module 16 may utilize one or more web-based protocols to serve content to non-web browser clients, such as a web-based mobile application residing and executing on a mobile computing device, a set-top box, a television, or some other computing device.

As is understood by skilled artisans in the relevant computer and Internet-related arts, each module or logic component shown in FIG. 1 represents a set of executable software instructions and the corresponding hardware (e.g., memory and processor(s)) for executing the instructions. To avoid obscuring the inventive subject matter with unnecessary detail, various functional modules and/or logic components that are not germane to conveying an understanding of the inventive subject matter have been omitted from FIG. 1. However, a skilled artisan will readily recognize that various additional functional modules and logic components may be used with a network- or web-based application, such as that illustrated in FIG. 1, to facilitate additional functionality that is not specifically described herein. Furthermore, the various functional modules and logic components depicted in FIG. 1 may reside on a single server computer, or may be distributed across several server computers in various arrangements.

As illustrated in FIG. 1, the client computer 20 executes a web browser application 18 to access the web-based question-and-answer application or service over a network. In various alternative embodiments, the client computer 20 may be a mobile computing device, to include: a laptop, mobile phone, e-book reader, or tablet computer. As such, with some embodiments, the question-and-answer application or service may have an interface that is customized for display in a browser, or mobile application, of a mobile device. Furthermore, with some embodiments, the client-based application may not be browser-based, but instead may be customized to suit the particular operating system of the device on which it is executing. For instance, a customized application may utilize one or more application programming interfaces (APIs) that are unique to the particular device and operating system on which the customized application resides and executes.

As shown in FIG. 1, the question-and-answer service 10 includes three separate content delivery or distribution channels 22 by which content may be communicated to users. For purposes of the present disclosure, a channel is a content delivery or distribution mechanism by which content—and, promoted content in particular—can be communicated and presented to a user. A content distribution channel may leverage an underlying communication mechanism, such as a web server module 16, an email or messaging platform, a short messaging service (SMS), a micro-blogging service, a telephone-based service, and so forth. In the particular embodiment of FIG. 1, three separate content distribution channels 22 are shown, including a content feed 24, notifications 26 and email or messaging 28. Of course, with other embodiments, different content distributions channels may also be used.

The question-and-answer application logic 14 shown in FIG. 1 includes a variety of application modules (not shown) that provide some of the core functionality of the application, to include a content posting module, a messaging and notifications module, and an ask-to-answer module. In general, the content posting module enables users to post questions, answers and comments, as well as other content-related items of information. The messaging and notifications module operates in conjunction with the content posting module to facilitate the generation and communication of messages and notifications, which are communicated to one or more users via one of the content distribution channels 22. Accordingly, when a first user posts an answer to a second user's question via the content posting module, the messaging and notifications module will cause a message or notification to be communicated to the second user, informing the second user of the newly posted answer to the question. The ask-to-answer module analyzes a variety of information to suggest to a user the names of other users who, for various reasons, may be persons to whom a question should be directed. Of course, the application logic 14 may include a number of other modules and logic components that perform a variety of other tasks and functions beyond the immediate scope of the present inventive subject matter. In particular, the inventive concepts described herein might be implemented with a question-and-answer application or service consistent with any one or more of the features and functionality described in related U.S. patent application Ser. No. 12/795,482, entitled, “Methods and Systems for Merging Topics Assigned to Content Items in an Online Community,” filed Jun. 7, 2012; U.S. patent application Ser. No. 12/983,056, entitled, “Methods and Systems for Soliciting an Answer to a Question,” filed Dec. 31, 2010; and, U.S. patent application Ser. No. 12/983,062, entitled, “A Multi-Functional Navigation Bar,” filed on Dec. 31, 2010. However, to avoid obscuring the inventive subject matter with unnecessary detail, various functional modules and logic components have not been included in FIG. 1.

With some embodiments, the content promotion module 12 enables a user to promote a particular item of content, such as a question, an answer, a topic, a blog posting, a content board or some other collection of aggregated content. A user may promote content items that the user has posted or published, as well as content items that other users have posted or published. For example, a user may promote a question that has been posted by another user and has not yet been answered, where the purpose of the promotion is to encourage other users to provide an answer to the promoted question. A user may post or publish a question, and then immediately promote the question with a view to encouraging others to provide an answer. In an effort to draw attention to a particular answer that a user has posted or published, and perhaps in hopes of receiving upvotes from other users, a user may promote the particular answer. A user who is trying to obtain knowledge across a particular topic may promote that topic with the objective of encouraging others to contribute answers to certain questions that are assigned to that topic. Of course, users may have other reasons for wanting to promote various items of content.

The content promotion module 12 provides an associated user interface via which a user can invoke or initiate a content promotion request. For example, the user interface of the content promotion module 12 may be presented in association with any number of content items that are eligible for promotion, including any of the aforementioned content items. With some embodiments, the user interface of the content promotion module 12 enables a user to specify one or more content promotion parameters that may affect the manner in which a particular content promotion is performed. For example, with some embodiments, a user may specify the reach or audience size for a particular content promotion. With some embodiments, a user may specify via the user interface of the content promotion module a content promotion parameter defining the length or duration of time that a content promotion is to be active. Similarly, a user may specify a particular start and/or end time for a content promotion that is to occur in the future. When a user invokes or initiates a content promotion request, any content promotion parameters specified by the user are communicated to the content promotion module 12 with the request. The content promotion parameters are then stored in a database, so that a subsequent request for the promoted content item can be processed to provide the promoted content item preferential treatment that is in accordance with the specified parameters.

With some embodiments, when a particular content item has been promoted by more than one user during the same timeframe, the content promotion module 12 will increase the resulting effects of the content promotion in an additive manner, for example, by simply doubling the reach of the content promotion so that the content item is viewed by more people. Alternatively, with some embodiments, a content item that has been promoted by more than one person during the same timeframe may effect the manner in which the content item is promoted, such that the content promotion is stronger. For example, when a content item has been promoted by more than one person in the same timeframe, the presentation (e.g., user interface) of the promoted content item may be modified in some way to draw additional attention to the promoted content item. Similarly, the promoted content item may be communicated or presented via additional distribution channels when subject to multiple content promotion requests. This stronger promotion may occur, for example, when a particular user is presented with an item of content as a result of being the target of two simultaneous content promotions. For example, the stronger promotion technique may occur when a user (e.g, User A) is being presented with a content item as a result of the content item being promoted by two separate users (e.g., Users B and C). In such a scenario, User A may be thought of as being doubly targeted by the two separate content promotions.

With some embodiments, and as illustrated in FIG. 1, the content promotion module 12 includes a user targeting module 30. The user targeting module 30 enables a user to specify user targeting criteria so that the content promotion can be directed to certain users who satisfy the specified user targeting criteria. For example, a user who is promoting a content item (e.g., a question) may specify as targeting criteria a particular geographical location, such that the content is promoted and provided with preferential processing only with respect to those users who reside in the specified geographical location. Similarly, a user may target a set of users who have expertise in a particular subject matter or topic, as evidenced by having posted a certain number of answers to questions assigned to the particular topic, or by having one or more answers voted up a number of times by other users. In some instances, a user may target a content promotion to only users who are currently online and/or interacting with the question-and-service. Of course, a wide variety of other user targeting criteria may be specified. Similar to the content promotion parameters, user targeting criteria are received when the user invokes or initiates a request, and are then stored so that the user targeting criteria can be used in the processing of subsequent content requests.

With some embodiments, when a user invokes or initiates a content promotion request for a particular item of content, any content promotion parameters as well as any user targeting criteria that are specified and associated with the request will be stored in a database 34, such as that with reference number 36. Accordingly, the content promotion parameters and user targeting criteria are accessed and used in the content selection and ranking process, when the promoted content item is being presented to another user.

A variety of other data may be stored in various databases 34 managed by a database management server 32. Specifically, as shown in FIG. 1, databases or database tables may exist for storing user profile data 38. Generally, user profile data 38 includes personal information about each user, such as their name, email address, telephone number, place of employment, educational background, and/or any other type of personal information that might be commonly found on a resume or curriculum vitae. With some embodiments, the user profile data 38 may additionally include location information indicating the geographical location of a residence or work place of a user, information indicating a user's experience (e.g., work, study, accomplishments, awards received, etc.), and/or information indicating one or more topics on which a user has expertise.

In addition to user profile data 38, social graph data 40 may be stored in a database 34. The social graph data 40 includes information about the various relationships that exist between users of the service, and the content (e.g., questions, answers, comments, blog posts, etc.) that each user has subscribed to, or follows. For example, with some embodiments, users can follow another user—a type of unilateral relationship—and then be informed about information posted to the service by the user that is being followed. In some instances, two users may follow one another—a bilateral relationship, sometimes referred to as a direct connection. Finally, any user-generated content, to include any of the various content items that might be promoted and presented in a content feed are stored in a database 42. The user-generated content 42 stored in the database tables include, for example, the text of questions, answers, comments, and so forth.

As illustrated in FIG. 1, the application logic 14 and the content promotion module 12 operate in conjunction with a credit management module 36. With some embodiments, the price to promote an item of content is measured in a virtual currency, referred to herein as credits. In general, the credit management module 36 shown in FIG. 1 is consistent with, and performs the various functions of, the credit management module described more completely in U.S. application Ser. No. 13/559,482, with title, “System of Credits for Use with a Network-Based Application,” filed on Jul. 26, 2012, and incorporated fully herein by reference. As users interact with the question-and-answer service 10, for example, by posting content, promoting new or previously posted content, asking others to answer questions, and taking certain actions, the credit management module 36 will process the credits associated with the various actions, for example, by debiting a user's credits account, and/or paying out credits to a user's credits account. In particular, when a user promotes an item of content, the content promotion module 12 will operate in conjunction with the credit management module 36 to debit a number of credits from a credits account of the user.

As illustrated in FIG. 1, the credit management module 36 includes a content promotion price-setting module 44. With some embodiments, the price-setting module 44 facilitates the manual setting of prices for content promotions. For example, via a user interface of the content promotion price-setting module 44, a user can establish various prices to be paid in exchange for requesting that a certain item of content be promoted. The price may vary, for example, by the particular type of content to be promoted, the number of persons to whom the item is to be presented in accordance with the promotion, and/or the length or duration of time during which the content promotion is to be active.

With some embodiments, the content promotion price-setting module 38 provides for the automatic or algorithmic setting of the price to be paid by users for promoting content items. Accordingly, the price-setting module 44 may analyze various input factors to derive the price for promoting a particular item of content or a particular type of content. For example, the price may be established on a per-user basis to reflect a measure of how effective a particular user is at promoting, or just posting, content. If, for example, other users regularly engage and/or interact with the content posted or promoted by a particular user—by commenting on, voting up, liking, re-sharing the content, and so forth—the price that particular user is charged to promote a content item may be decreased relative to what other users are required to pay to promote content. With some embodiments, the price-setting module 38 may, over time, automatically increase and decrease the price to promote content in order to achieve a desired ratio of promoted to non-promoted content appearing in a particular content distribution channel, such as a content feed. In other instances, the price-setting module 38 may establish the price for promoting an item of content based on some metric representing the quality, or expected quality, of the content item being promoted. Accordingly, a content item that has a low quality score (e.g., such as spam) may be more costly to promote.

The price-setting module 44 will perform other functions as well. For instance, with some embodiments, the price-setting module 36 may operate in conjunction with the content promotion module 12 to dynamically derive a price, based on one or more content promotion parameters specified by a user, so that the price is updated and conveyed to the user in real time as the user specifies and/or changes a particular content promotion parameter. For instance, via a user interface of the content promotion module 12, a user may specify certain content promotion parameters, such as, the number of users to whom a particular content item is to be promoted, or, the duration of time that a content item is to be promoted. Any of a wide variety of user interface elements may be used to enable the user to select or otherwise specify the particular content promotion parameters, such as a slider bar, drop down list, simple text input box, and so forth. As the user selects or specifies the particular content promotion parameters, the price-setting module 44 will automatically update the price for promoting a content item, which is conveyed to the user via the user interface of the content promotion module 12. When a user finally elects to promote a particular item of content with certain content promotion parameters, a content promotion request is generated. The credit management module 36 will then debit a number of credits equal to the price for promoting the content item from a credits account of the user.

When a user requests a web page or user interface via which content items (e.g., questions, answers, topics, etc.) are to be presented, for example, via a content feed, the content selection module 40 will select the appropriate or eligible content items for presentation in the personalized content feed of the user. However, before presenting the selected content items, the relevance module assigns to each content item a relevance or ranking score. If a particular item has been promoted, the ranking score assigned to the item by the relevance module 48 may be boosted or increased in accordance with some preferential processing for promoted content items, to ensure that the promoted content item is positioned prominently in the content feed of the requesting user. Additionally, the relevance module may retrieve the content promotion parameters associated with any promoted content items to ensure that any preferential processing performed for the promoted content item is performed in accordance with the content promotion parameters. The content presentation module 50 may modify the format of a promoted content item when the promoted content item is being presented to a user. In some instances, a promoted content item may be presented with some additional user interface element(s) to convey to the viewing user that the particular item of content has been promoted. Similarly, in some instances, the format of the content item is modified to simply draw attention to the fact that the content item has been promoted. With some embodiments, when a user is promoting a content item, the user may specify via one or more content promotion parameters some specific content formatting options (e.g., size, color, shape, etc.) for the promoted content item. Furthermore, with some embodiments, the price to promote a content item may vary based on the user selecting different content formatting options for an item of content being promoted. Finally, when a promoted content item is presented to a user, for example, via a personalized content feed, the event is logged in a database to ensure that the same promoted content item is not repeatedly presented to the same user as part of the same content promotion request.

With some embodiments, some of the various functional components of the question-and-answer application, including some of the various software modules, may be distributed across several server computers, providing application reliability and scalability. For instance, as illustrated in FIG. 1, the database management server 32 is shown to reside on a separate server computer. However, in other embodiments the database management server 32 might reside and execute at the same server as the application logic 14, web server module 16 and/or content promotion module 12. In any case, the database management server 32 facilitates the writing and reading of data stored in tables of a database 34. With some alternative embodiments, other data structures may be utilized in addition to, or in place of, database tables.

Consistent with some embodiments, the question-and-answer service is a stand-alone service accessible via its own unique address (e.g., URL or URI). With some embodiments, the stand-alone service may leverage its own social layer or social graph (e.g., such as the social graph data 40), or a social layer or social graph that is provided by an externally-hosted social network service. Accordingly, various relationships between users, as determined or defined by the question-and-answer service 10 or an externally-hosted social network service, may be utilized to customize the functionality and features of the question-and-answer service 10. For example, search results displayed via a navigation bar may be ranked and ordered based, at least in part, on the relationship that the user performing the search has with other users, as that relationship is defined by the question-and-answer service, or an external social network service. Alternatively, with some embodiments, the question-and-answer service may be one of several applications or services that are associated with, and provided by, a social network service. For instance, the question-and-answer service 10 may be accessible via the same address or domain by which users access a social network service, such that the question-and-answer service is hosted by the same entity providing the social network service.

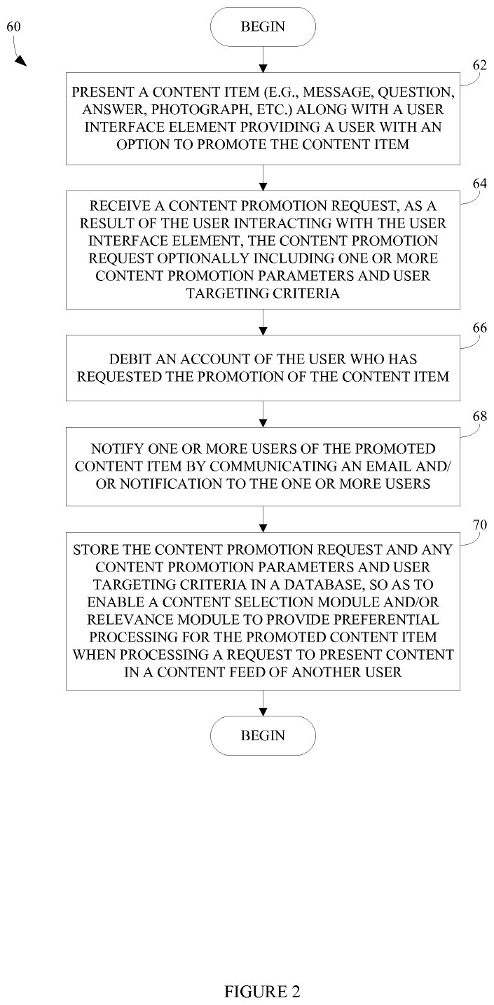

FIG. 2 is a flow diagram illustrating an example of the method operations performed when a user of a question-and-answer service promotes a content item, according to some embodiments of the invention. In general, the method 60 begins when, in response to a content request, at method operation 62 a particular content item is presented to a user along with a user interface element that provides the user with an option to promote the content item. The content item may be presented via any number of content delivery channels. For example, the content item may be a message or status update in a content feed of a social network service. In the context of a question-and-answer service, the content item may be a question, an answer, or a topic, and may be presented in a content feed of the user, or in a dedicated web page, such as a question page. The content item may have been posted by the user viewing the content item, or posted by another user. The user interface element providing the option to promote the content item may take any of a variety of forms, and may, for example, provide a variety of interactive elements enabling the user to specify content promotion parameters, and/or user targeting criteria.

At method operation 64, a content promotion module receives a content promotion request as a result of the user interacting with the user interface element that had been presented with the content item. For example, the user may have optionally specified one or more content promotion parameters and some user targeting criteria, and then selected a particular button or link to invoke or initiate the content promotion request. With some embodiments, the price that the user is required to pay in exchange for requesting that the content item be promoted is presented with the user interface element that provides the user with the option to promote the content item. The price may be dynamically updated in response to various content promotion parameters and user targeting criteria specified by the user.

In any case, at method operation 66, when the content promotion request is received, an account of the user may optionally be debited an amount equivalent to the price for promoting the content. With some embodiments, the price is paid in some form of virtual currency, while in other embodiments, a payment processing module may provide for processing a payment in an actual currency.

At method operation 68, the promoted content item may optionally be communicated to one or more users via a content distribution channel such as a notification or email. For instance, with some embodiments, when a content item is promoted, the promoted content item may be pushed to one or more users as part of the promotion. The notification or email may include a selection of the most relevant content for the recipient user, and may include one or more promoted content items.

Finally, at method operation 70, as a result of processing the content promotion request, certain information is stored in a database, including an indication that the content item has been promoted and any content promotion parameters and/or user targeting criteria for the content promotion. By storing this information in a database, subsequent content requests can utilize the information to provide the particular content item preferential processing in accordance with the parameters of the content promotion.

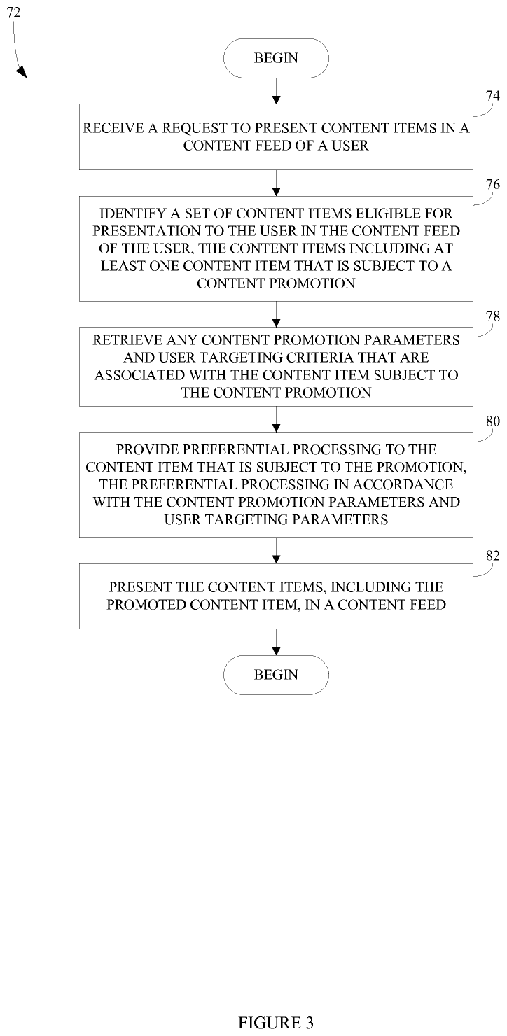

FIG. 3 is a flow diagram illustrating an example of the method operations performed when a set of content items that includes one or more promoted content items is selected for presentation to a user via a content distribution channel, consistent with some embodiments of the invention. The method 72 begins at method operation 72 when a request to present items in a content feed of a user is received. At method operation 76, in response to the request a content selection module identifies a set of content items that are eligible for presentation in the content feed of the user. For example, the content selection module may use various selection criteria to select a set of content items that are to be presented in the user's content feed, where the content items include at least one content item that is subject to a promotion—that is, the content item has been promoted by another user. At method operation 78, for any content items that are subject to content promotions, the content promotion parameters (if any) and the user targeting criteria (if any) are retrieved.

At method operation 80, a relevance algorithm assigns a ranking score to each content item eligible for presentation in the content feed of the user, where the promoted content items are provided preferential processing in accordance with any content promotion parameters and user targeting criteria or parameters. The preferential processing may, for example, result in the promoted content items being ranked more highly than some or all of the content items that are not subject to promoting. Similarly, the preferential processing may result in the appearance or format of the promoted content items being modified from their original (e.g., non-promoted) form, and so forth. Finally, at method operation 82, the content items are presented to the user in the content feed.

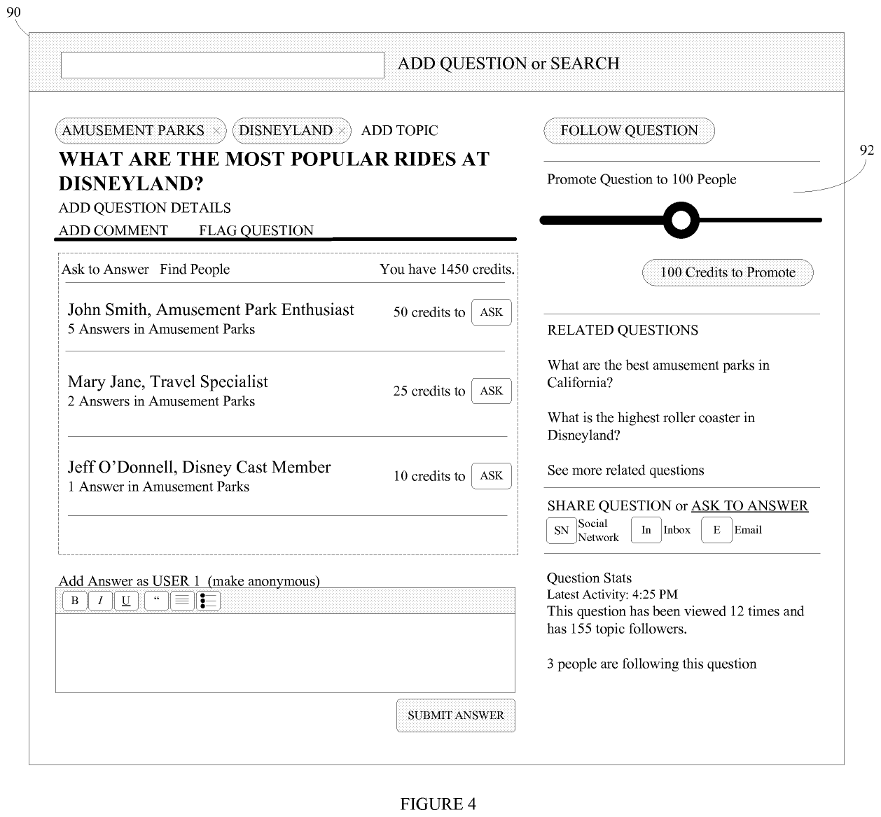

FIG. 4 is a user interface diagram illustrating an example of a web page of a question-and-answer service, and in particular a question page having a content promotion interface via which a user can promote a question, consistent with some embodiments of the invention. The example web page 90 of FIG. 4 is a web page dedicated to a particular question that has been posted or published to the question-and-answer service. In this particular example, the question has been assigned to two different topics, “Amusement Parks,” and “Disneyland.” If the user viewing the question page is interested in obtaining an answer to the question, the user may consider promoting the question, so that the question obtains greater collective user-attention from other users.

In this example, the portion of the user interface with reference number 92 represents a user interface of a content promotion module, and generally enables the viewing user to invoke or initiate a content promotion request. For example, the slider bar can be manipulated by moving the selector to the left or right, thereby changing the number of people to whom the question will be presented in accordance with the content promotion. As the user manipulates the slide bar, the price payable in credits is automatically updated and conveyed to the user, to reflect changes in price due to changes in the reach or audience size of the promotion. As shown in FIG. 4, the ratio of the number of credits to the number of people in the target audience is one-to-one, this will not necessarily always be the case. In other embodiments, the ratio may vary and be greater or less than one-to-one.

As shown in FIG. 4, the user who is requesting that a content item be promoted may specify the particular number of users to whom the content item is to be presented in accordance with the promotion. With some embodiments, the target audience may, by default or by means of some additional user-specified content promotion parameters, include only users satisfying some characteristic. For example, the targeted audience may include only users who are currently following the topic to which the content item relates. Alternatively, the targeted audience may include only the users who are currently online. Similarly, the targeted audience may be filtered or otherwise selected by some other characteristic.

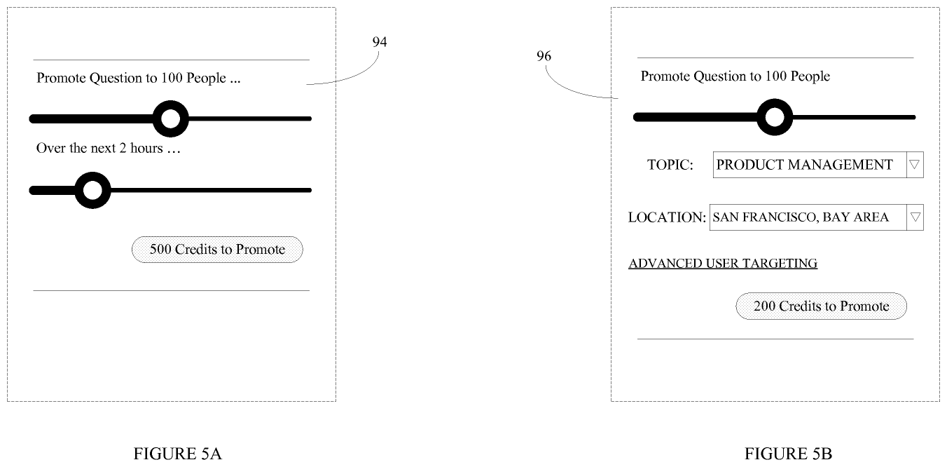

FIGS. 5A and 5B are user interface diagrams illustrating alternative user interfaces for a content promotion module via which users can promote content items and specify content promotion parameters, consistent with some embodiments of the invention. With some embodiments, when a user is promoting an item of content the user can specify various content promotion parameters that will influence various factors in determining how the content promotion is performed. For example, in the example user interface of FIG. 5A, the user can specify both the number of people who are to be presented with the promoted content item, in accordance with the promotion, and the specific duration of time during which the content promotion is to occur. In this example, the user has selected to promote the content item to one hundred people over the next two hours. The price for such a promotion may vary based on the specified content promotion parameters—particular the reach and duration of the content promotion.

In the example user interface of FIG. 5B, the user is provided with an opportunity to specify various user targeting criteria to be used in selecting the users to whom the content item is to be promoted. In this example, the user has selected users having a particular expertise (e.g., “Product Management”) and users residing in a particular location (e.g., “San Francisco, Bay Area”). By selecting the “Advanced User Targeting Criteria” button or link, the user may be presented with a variety of other criteria by which users can be targeted to receive the content item as part of the promotion.

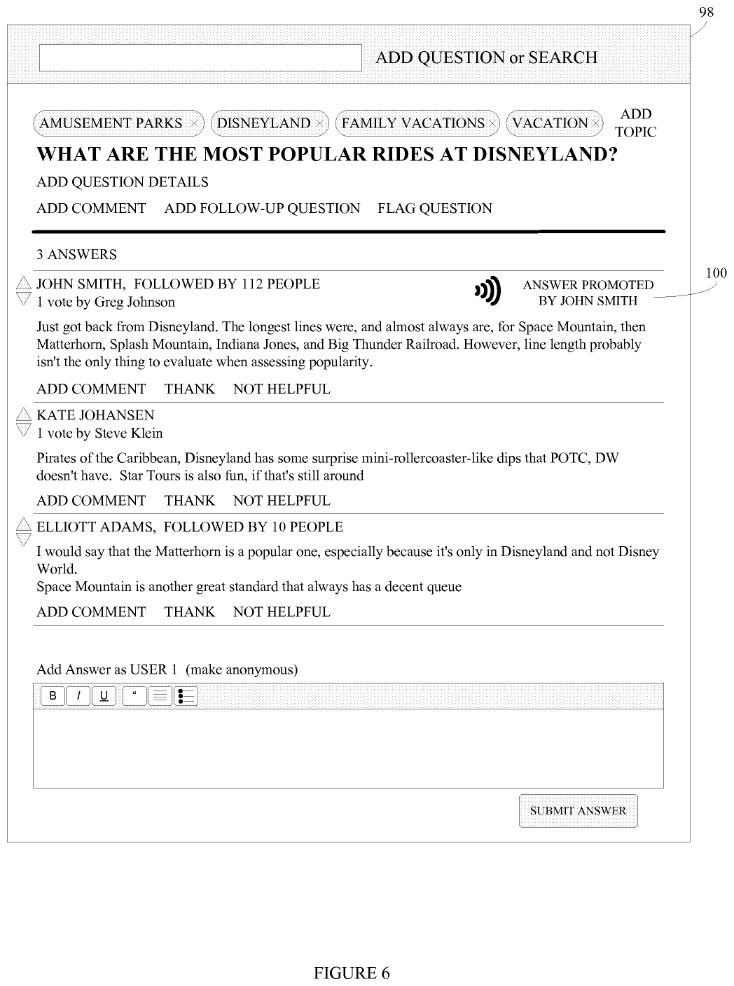

FIG. 6 is a user interface diagram illustrating an example of a web page of a question-and-answer service, and in particular a question page in which an answer to a question has been promoted, consistent with some embodiments of the invention. As shown in the example question page 98 of FIG. 6, a particular answer to the question presented on the question page has been promoted, as indicated by the user interface element with reference number 100. In this example, the name of the user who has promoted the answer is presented along with the icon or graphic indicating that the answer has been promoted.

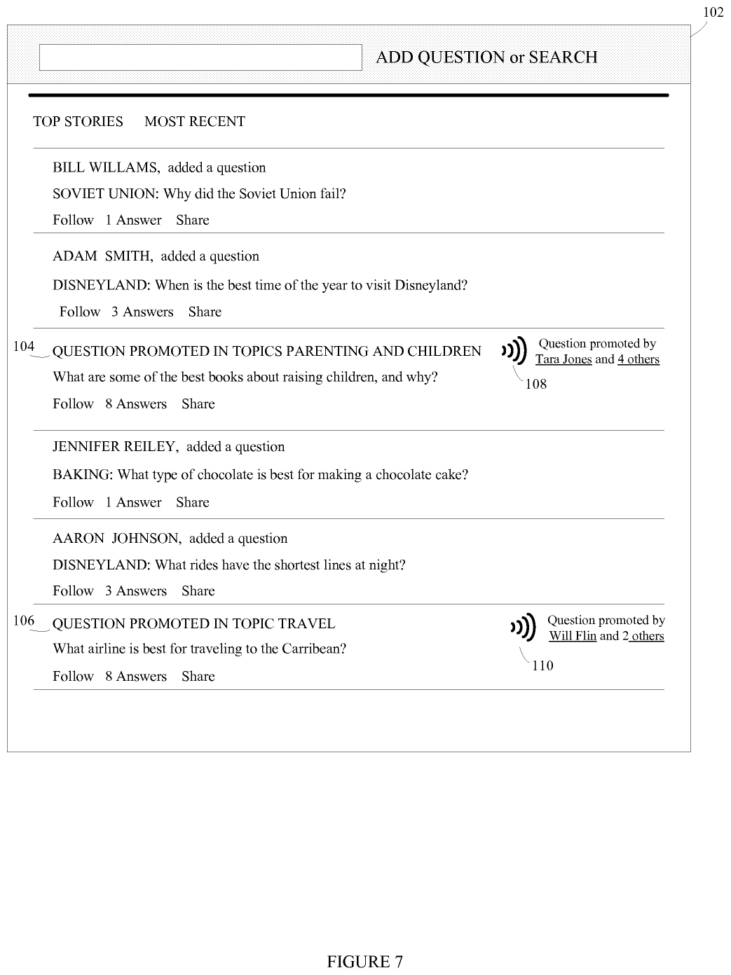

FIG. 7 is a user interface diagram illustrating an example of a web page 102 showing a content stream or feed, including content items that have been promoted, consistent with embodiments of the invention. As illustrated in FIG. 7, the content feed includes several content items, including two content items that are presently subject to content promotions (e.g., content items with reference numbers 104 and 106. With some embodiments, the content items presented in the content feed for a particular user are selected based on some algorithm that takes various factors into consideration, including the relationship between the viewing user and the posting user (e.g., the user who has posted or shared the content), the quality of the content items, and so forth. As described above, when an item of content has been promoted, such as the question with reference number 104, the promotion of the content item effects the selection and ordering process, such that the promoted content item is more likely to appear in a user's content feed. As illustrated in FIG. 7, the two promoted content items are presented with a symbol (e.g., symbols 108 and 110) to specifically indicate that those content items have been promoted. In addition, as illustrated in FIG. 7, information about which users have promoted an item of content may be presented. For example, in FIG. 7, the content item with reference number 104 has been promoted by “Tara Jones” and four other users, where the identity of the four other users may be presented when the viewing users interacts with the user interface element with reference number 108.

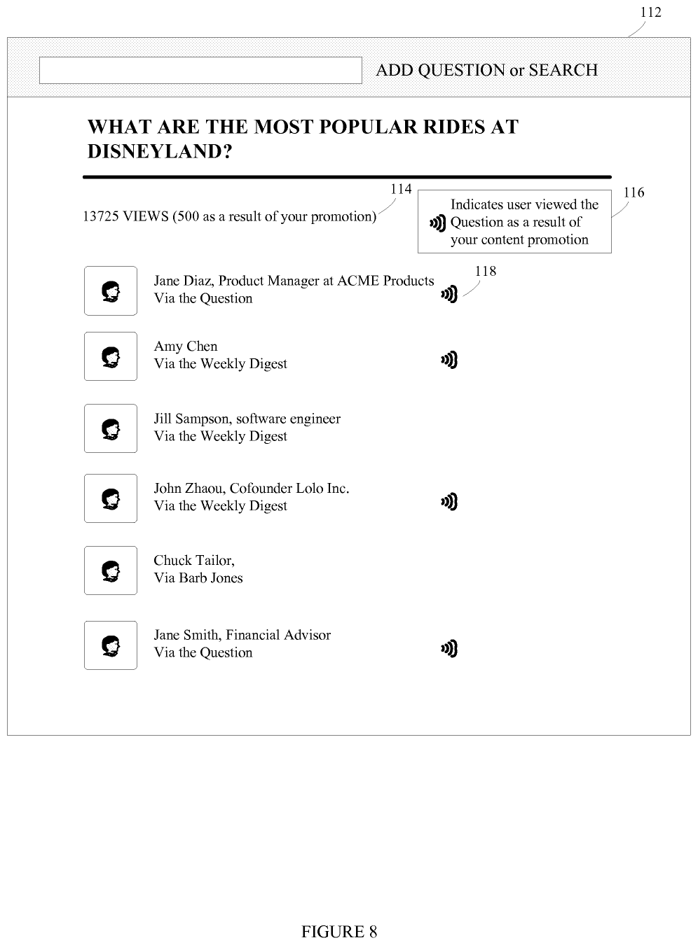

FIG. 8 is a user interface diagram illustrating an example of a web page 112 of a question-and-answer service, and in particular a page showing the users who have viewed a particular question, and which of those users viewed the question as a result of that question having been promoted, consistent with some embodiments of the invention. In the example page 112 of FIG. 8, the information has been personalized for the viewing user, for example, by indicating with a special user interface element or symbol the particular users who viewed the question shown at the top of the page as a result of a content promotion request submitted by the viewing users. As indicated by the text with reference number 114, 13,725 users have viewed the question and five hundred of those users viewed the question as a result of the content item being promoted by the viewing user (i.e., the user viewing the web page 112). As indicated by the text and symbol associated with reference number 116, a special symbol, graphic, or icon appears next to those users who viewed the question as a result of the content promotion request submitted by the viewing user. While the example page illustrated in FIG. 8 shows the particular users who have viewed a question, in other instances, a user may be presented with information identifying the users who have viewed some other type of content, including a blog posting, a status update, a photograph, an answer, a comment, or any other type of content. With some embodiments, in addition to simply showing the users who have viewed a particular item of content, other information may be presented as well. For example, with some embodiments, various user characteristics about the user who have viewed an item of content as a result of the content promotion may be presented. For instance, the information may include demographic information about the users, topics the users are following and other information.

With some embodiments, promoted content items may appear in a variety of other user interfaces or contexts not explicitly presented herein. For instance, with some embodiments, a separate distribution channel may be defined to show all content items of a particular type that are currently subject to a content promotion. Accordingly, in the context of a question and answer service, a user might view all open or unanswered questions that are currently subject to a content promotion. By further filtering those questions based on the topic or topics to which the questions are assigned, the user can quickly identify and browse promoted, unanswered questions of interest to the users. Similarly, in the context of a social network service, or a blog posting service, a user may be able to view all status updates, photographs, blog postings, etc. that are currently subject to a content promotion.

Skilled artisans will recognize that the methods and user interfaces presented herein are presented as specific examples of how the inventive concepts may be implemented. However, methods and user interfaces that differ from the specific examples presented herein may be consistent with the general scope and spirit of the inventive concepts. Particularly, the order in which certain method operations occur may vary from the examples presented herein without departing from the scope and spirit of the inventive concepts. Similarly, a wide variety of user interface elements different from those presented herein may be used to implement the inventive concepts described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules or logical components referred to herein may, in some example embodiments, comprise processor-implemented modules or logic.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

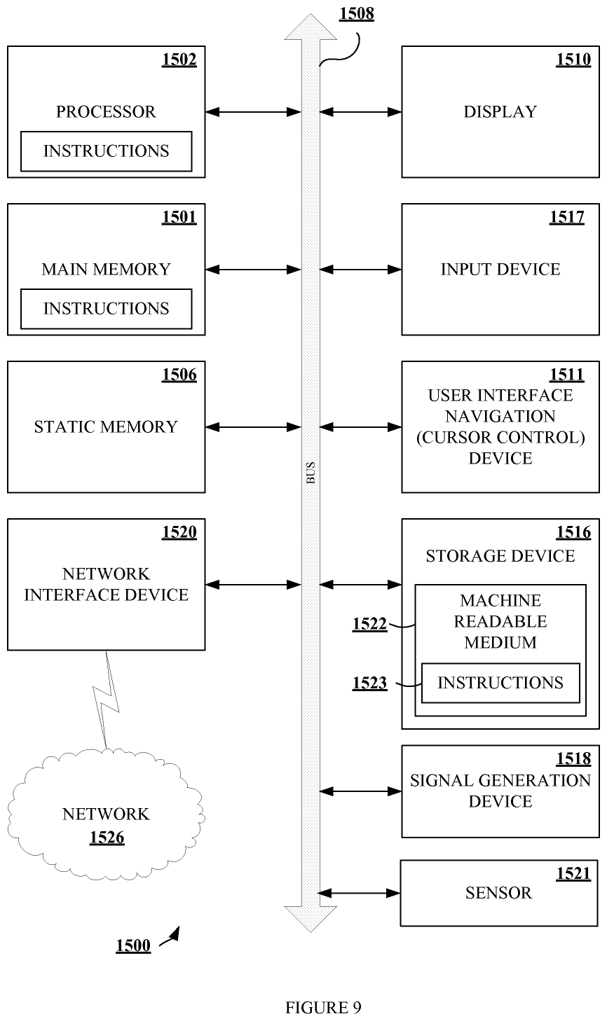

FIG. 9 is a block diagram of a machine in the form of a computer within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environments, or as a peer machine in peer-to-peer (or distributed) network environments. The machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device (e.g., drive unit 1516), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although embodiments of the inventive subject matter have been described with reference to specific examples, it will be evident that various modifications and changes may be made to these examples without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method to facilitate promotion of a content item via a network-based application, the method comprising:
presenting with the content item a user interface element providing a first user with an option to promote the content item,
receiving, at a processor-implemented content promotion module, a content promotion request for the content item, the content promotion request received as a result of the first user interacting with the user interface element;
subsequent to receiving the content promotion request and until some predetermined condition is satisfied, for each request to present to a user other than the first user a set of content items in a content feed, promoting the content item by providing preferential processing for the content item when determining a set of content items to be presented to a user.
